(19) United States
(12) Patent Application Publication
(10) Pub. No.: US 2006/0161802 A1
(43) Pub. Date: Jul. 20, 2006

(54) Backup/recovery system and methods regarding the same

(75) Inventors: George Wang, Chongqing (CN); Makson Zhao, Chongqing (CN)

Correspondence Address: ARENT FOX PLLC, 1050 CONNECTICUT AVENUE, N.W., SUITE 400, WASHINGTON, DC, 20036, US

(73) Assignee: FarStone Tech, Inc.

(21) Appl. No.: 11/325,520

(22) Filed: Jan. 5, 2006

(30) Foreign Application Priority Data
Jan. 14, 2005 (TW) 94101057

(51) Int. Cl. G06F 11/00

(52) U.S. Cl. 714/4

(57) ABSTRACT

A network backup/recovery system is provided which can furnish backup service and/or recovery service via a network, which can minimize time consumption and cost. The network backup/recovery system comprises a management unit for managing at least one client and a processing unit for providing the backup/restore service and transmitting the backup/restore service to the client through the management unit. The client implements a predetermined operation according to said received backup/restore service.

### CROSS-REFERENCE TO RELATED APPLICATIONS

The present application claims priority, under 35 U.S.C. § 119, to foreign application no. 94101057 filed Jan. 14, 2005 in Taiwan, the contents thereof incorporated by reference herein by its entirety.

### BACKGROUND OF THE INVENTION

1. Field of Invention

The present invention relates generally to a backup/recovery technique for a network environment, and more particularly to a backup/recovery system and method that automatically uninstalls a backup/recovery program via a network.

2. Description of Related Art

The protection for the computer system is an important issue at present. In general, the disks can go bad, files can be deleted by mistake, and virus infections can render files useless. Backing up the hard drive regularly is a must. All systems should have a backup/recovery system to backup computers nowadays.

Backups should be done on a regular schedule. There are always several sets of backups available in case it is necessary to restore files. Conventional backup/recovery techniques often establish recovery points to backup data in a computer system for reverting to an earlier version of a file, data, or program.

These backup/recovery techniques can be generally classified into two types. The first type is a static backup/recovery technique, and the second type is a dynamic backup/recovery technique. Backing up data with the static backup technique can normally store the backed-up data over a long period of time. In contrast, the dynamic backup technique has the advantage of using the storage space of a hard disk of the computer system in a more effective way when backing up the data.

Conventional backup/recovery software can also be classified into a static backup/recovery type software and a dynamic backup/recovery type software. The static backup/recovery type software, such as the Ghost software developed by Symantec Corporation, adopts a static backup technique in establishing recovery points in the data backup process. And the dynamic backup/recovery software, such as the Goback software developed by Adaptec Corporation and the Pro Magic software developed by WASAY Incorporation, adopts a dynamic backup technique in establishing recovery points in the data backup process.

Such Ghost software developed by Symantec Corporation backs up all valid data of those data being in a state of maintenance. Accordingly to the conventional backup/recovery software, backing up data by this static backup technique takes up fixed storage space of the hard disk in the computer system. Moreover, the backed-up data is kept in a state of perpetuity, independent of other current or future data contained in the hard disk of the computer system.

When the static backup/recovery program is executed to back up data, all data stored in selected partitions of the hard disk is backed up to a file. In addition, when the static backup/recovery type program is executed to recover data, the data from the previously backed up file is restored to the selected partitions of the hard disk.

Such Goback software developed by Adaptec Corporation or Pro Magic software developed by WASAY Incorporation restores the computer system to a previous state, in accordance with the backed up data, from a current state. The valid data is backed up prior to making changes to the data. The backup file contains the backup data and identification information to identify the backup data. Such identification information is useful in restoring the computer system in the future.

Although the conventional backup/recovery software has the backup/recovery capabilities to back up and/or recover data in the hard disk, the backup/recovery operation is complicated using the current conventional backup/recovery techniques. Moreover, setting up the conventional backup/recovery software is a time-consuming task. The intricate installation of the conventional backup/recovery software requires a skilled person. The conventional backup/recovery software is too complicated for the user. Hence, the price for purchasing the conventional backup/recovery software is extremely high.

On the other hand, the usage of the computer varies. The individual responsible for backing up and recovering depends on whether the computer is connected to network or is “stand-alone”. On a network, a backup of the network drives should be done every night. Users can use the “stand-alone” computer in a way that is more secure. His or her computer never goes “belly up”. The user does not need to restore the computer system to any previous state. In this case, the user may never implement the conventional backup/recovery software.

Owing to the conventional backup/recovery software offers a trial version; the user can try it for free. Though the trial version is a time-limited version for evaluation, the user may keep changing the system time. The trial period will never be expired. Thus, the price for the conventional backup/recovery software is high to cover the loss suffered by such user.

### BRIEF SUMMARY OF THE INVENTION

The present invention provides a backup/recovery system and method to resolve the foregoing problems faced by the conventional backup/recovery software. The present invention also has the advantage of providing a simple and cost-effective way to engage the backup/recovery solution for the users.

An object of the present invention is to provide a backup/recovery system and method, wherein the user can use a backup/recovery service via a network. The backup/recovery service is offered by a website.

Another object of the present invention is to provide a backup/recovery system and method, which can run the installation program and the backup operation in the background by clicking a button to initiate the backup/recovery service.

A further object of the present invention is to provide a backup/recovery system and method, which can restore the computer system to a previous state with the backup/recovery service provided by the website.

In accordance with an aspect of the present invention, a network recovery system is used for providing a backup/restore service via a network. The network recovery system comprises a management unit and a processing unit. The management unit is used for managing at least one client. The processing unit is used for providing the backup/restore service and transmitting the backup/restore service to the at least one client through the management unit. The at least one client implements a predetermined operation according to the received backup/restore service.

In the preferred embodiment of the invention, the processing unit includes a network interface for connecting the network and transmitting data. The processing unit includes a backup/restore module for backing up data and restoring a storage device to a previous state. The at least one client includes a browser coupled to a website. The at least one client includes a processing module for issuing a request for the backup/restore service to the website.

In accordance with another aspect of the present invention, a recovery system is used for providing a backup/restore service via a network. The recovery system comprises a client system and a server system. The client system is used for issuing a request for the backup/restore service. The server system is used for receiving the request via the network. The client system implements a predetermined backup/restore operation designated in the backup/restore service.

In the preferred embodiment of the invention, the server system includes a network interface for connecting the network and transmitting data. The server system includes a backup/restore module for backing up data and restoring a storage device to a previous state. The client system includes a browser coupled to a website. The client system includes a processing module for issuing the request for the backup/restore service to the website.

In accordance with still another aspect of the present invention, a system is used for providing a backup/restore service via a network. The system comprises a network interface and a backup/restore module. The network interface is used for connecting the network and transmitting data. The backup/restore module is used for backing up data and restoring a storage device to a previous state.

In the preferred embodiment of the invention, the network interface connects a client system. The client system includes a browser coupled to a website. The client system includes a processing module for issuing a request for the backup/restore service to the website.

In accordance with yet another aspect of the present invention, a system is used for utilizing a backup/restore service via a network. The system comprises a browser and a processing module. The browser is coupled to a website. The processing module is used for issuing a request for the backup/restore service to the website.

In the preferred embodiment of the invention, the website includes a backup/restore system for backing up data and restoring a storage device to a previous state.

In accordance with a further aspect of the present invention, a recovery method is suitable for providing a backup/restore service via a network. The method comprising the steps of: issuing a request for the backup/restore service; and implementing a predetermined backup/restore operation designated in the backup/restore service received through the network.

In the preferred embodiment of the invention, the recovery method further comprises a payment step in which a client system implements a payment procedure through the network prior to receiving the backup/restore service.

In accordance with still yet another aspect of the present invention, a recovery method is suitable for providing a backup/restore service via a network. The method comprising the steps of: connecting a client system to a website issuing a request for the backup/restore service; and enabling/disabling a predetermined backup/restore operation implemented in the client system, replied to the request.

In the preferred embodiment of the invention, the recovery method further comprises a payment step in which the client system implements a payment procedure through the network prior to receiving the backup/restore service.

The present invention may best be understood through the following description with reference to the accompanying drawings, in which:

### BRIEF DESCRIPTION OF THE DRAWINGS

FIG. 1 shows a schematic block diagram of a backup/recovery system of a preferred embodiment according to the present invention.

FIG. 2 shows a schematic flow chart of an installation method of the preferred embodiment according to the present invention.

FIG. 3 shows a schematic flow chart of a backup/recovery method of the preferred embodiment according to the present invention, wherein a backup/recovery service is provided.

FIG. 4 shows another schematic flow chart of a backup/recovery method of the preferred embodiment according to the present invention, wherein another backup/recovery service is provided.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention adopts a new business model to control or reduce purchase and maintenance costs. There is no longer need to buy a higher cost version of a backup/recovery software. The user can retain a service of the conventional backup/recovery software from an ASP provider on a cost-efficient budget.

With the backup service and/or recovery service of the present invention, the users can easily back up data and restore the computer system over the Internet. The computer system can be secured and the files will never be corrupted.

According to the preferred embodiment of the present invention, a network recovery system is used for providing a backup/restore service via a network. The network recovery system comprises a management unit for managing at least one client; and a processing unit for providing the backup/restore service and transmitting the backup/restore service to the at least one client through the management unit, wherein the at least one client implements a predetermined operation according to the received backup/restore service.

The processing unit includes a network interface for connecting the network and transmitting data. The processing unit includes a backup/restore module for backing up data and restoring a storage device to a previous state. The at least one client includes a browser coupled to a website. The at least one client includes a processing module for issuing a request for the backup/restore service to the website.

According to the preferred embodiment of the present invention, a recovery system is used for providing a backup/restore service via a network. The recovery system comprises a client system for issuing a request for the backup/restore service; and a server system for receiving the request via the network; wherein the client system implements a predetermined backup/restore operation designated in the backup/restore service.

The server system includes a network interface for connecting the network and transmitting data. The server system includes a backup/restore module for backing up data and restoring a storage device to a previous state. The client system includes a browser coupled to a website. The client system includes a processing module for issuing the request for the backup/restore service to the website.

According to the preferred embodiment of the present invention, a system is used for providing a backup/restore service via a network. The system comprises a network interface and a backup/restore module. The network interface is used for connecting the network and transmitting data. The backup/restore module is used for backing up data and restoring a storage device to a previous state.

The network interface connects a client system. The client system includes a browser coupled to a website. The client system includes a processing module for issuing a request for the backup/restore service to the website.

According to the preferred embodiment of the present invention, there is another system used for utilizing a backup/restore service via a network. The system comprises a browser and a processing module. The browser is coupled to a website. The processing module is used for issuing a request for the backup/restore service to the website.

The website includes a backup/restore system for backing up data and restoring a storage device to a previous state.

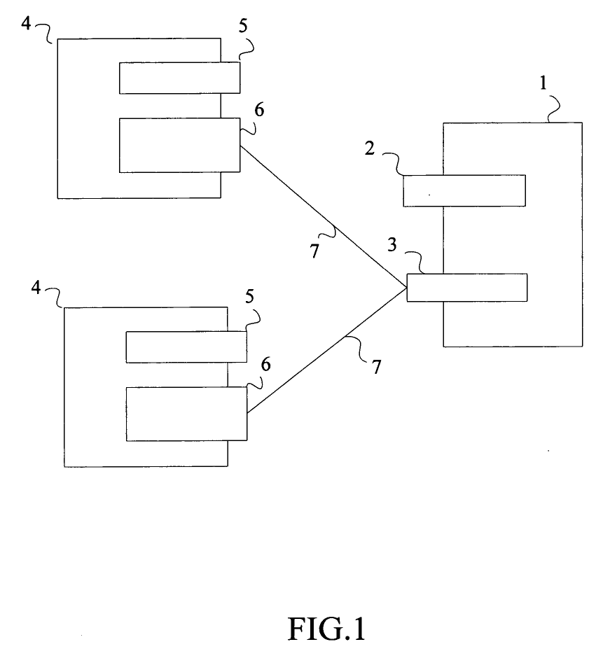

Referring to FIG. 1, a schematic block diagram of a backup/recovery system of a preferred embodiment according to the present invention is shown. The backup/recovery system of the present invention is used for providing a backup/restore service via a network 7. The backup/recovery system comprises a management system and a processing system.

The management system manages at least one client 4. As shown in FIG. 1, the at least one client 4 includes a client system 41 and 42. The processing system with a server system 1 provides the backup/restore service and transmits the backup/restore service to the at least one client 4 through the management system.

The server system 1 comprises a network interface 3 and a backup/restore module 2. The network interface 3 is used for connecting the network 7 and transmitting data. The backup/restore module 2 is used for backing up data and restoring a storage device to a previous state.

The network interface 3 connects the client system 4. The client system 4 includes a browser 6 coupled to a website. The client system 4 includes a processing module 5 for issuing a request for the backup/restore service to the website controlled by the server system 1.

The server system 1 receives the request from the client system 4 via the network 7. The client system 4 accesses the website controlled by the server system 1 and implements a predetermined backup/restore operation designated in the backup/restore service.

According to the preferred embodiment of the present invention, a recovery method is suitable for providing a backup/restore service via a network. The method comprising the steps of: issuing a request for the backup/restore service; and implementing a predetermined backup/restore operation designated in the backup/restore service received through the network.

The recovery method further comprises a payment step in which a client system implements a payment procedure through the network prior to receiving the backup/restore service.

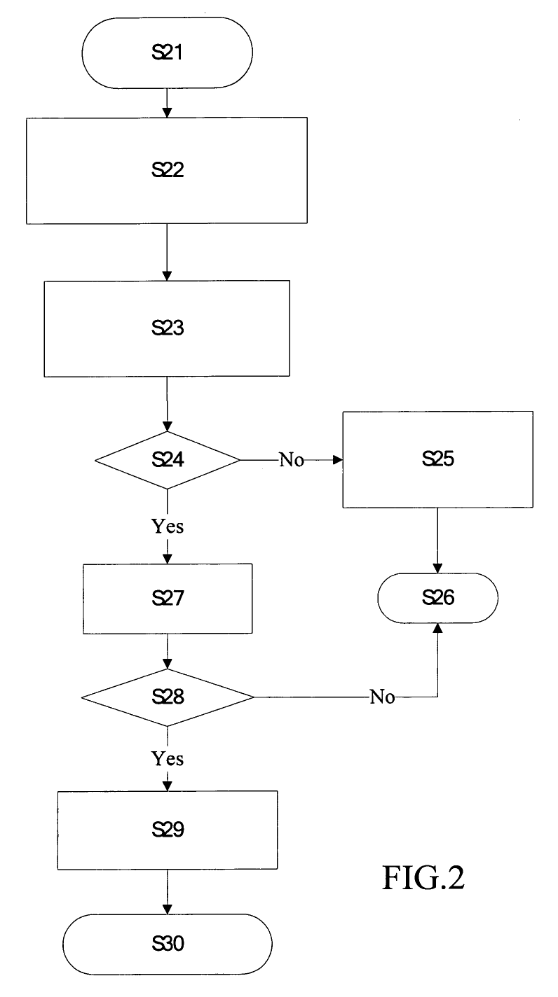

Referring to FIG. 2, a schematic flow chart of an installation method of the preferred embodiment according to the present invention is shown. According to the present invention, the installation method in the recovery method of the present invention is suitable for a backup/recovery system, which is to be installed in a computer system.

In step S21, the user connects her or his computer system to a designated website. In step S22, the client system transmits a request for installing a backup/restore system. The user may select type of the backup/restore service provided by the designated website, such as a sector type of the backup/restore service or file type of the backup/restore service. Next the user clicks a “Start” button.

In step S23, the server system 1 receives the installation request from the client system 4 via the network 7. In step S24, the backup/restore service initiates a check operation. Such check operation performs hardware checkup of the client system 4. If the hardware meets need of the backup/restore service, then the server system 1 continues at step S27, else the server system 1 continues at step S25.

In step S25, the server system 1 prompts the client system 4 that the backup/restore service cannot be operated in her or his computer system. In step S26, the installation operation is withdrawn.

In step S27, the client system 4 installs the backup/restore system. Before the installation operation is issued, the server system 1 may require the user to be registered to offer the backup/restore service. By way of this registration, the user pays fees over the Internet. In step S28, if the user pays fees for the backup/restore service, then the server system continues at step S29, else the server system continues at step S26. In step S29, the server system provides the backup/restore system to be installed in background. A password will be installed in the client system 4. In step S30, after the installation operation is completed, then the backup operation can be operated to backup data of the client system 4.

According to the preferred embodiment of the present invention, there is another recovery method is suitable for providing a backup/restore service via a network. The method comprising the steps of: connecting a client system to a website issuing a request for the backup/restore service; and enabling/disabling a predetermined backup/restore operation implemented in the client system, replied to the request.

Another recovery method further comprises a payment step in which the client system implements a payment procedure through the network prior to receiving the backup/restore service.

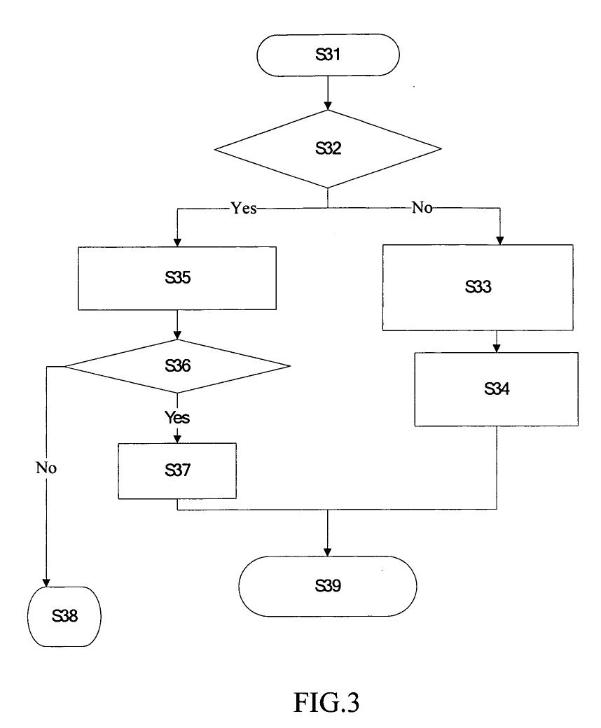

Referring to FIG. 3, a schematic flow chart of a backup/recovery method of the preferred embodiment according to the present invention is shown. According to the present invention, the backup/recovery method of the present invention is suitable for a backup/recovery system, wherein the backup/restore system is installed.

In step S31, the user requests the recovery service. In step S32, the backup/restore system determines whether the client system 4 is capable of loading an Operating System (OS) successfully and connecting the server system 1. If the OS cannot be loaded, and the client system 4 cannot connect the server system 1, then the backup/restore system continues at step S33, else the backup/restore system continues at step S35.

In step S33, the user reaches the service provider. The user pays for the recovery service and gets confidential information, such as a password. In step S34, the client system 4 starts executing in the real-mode operating environment. The user inputs the password obtained from the service provider. Then a recovery interface is displayed.

In step S35, the client system 4 connects a website. The user may click a button to request for the backup/recovery service. In step S36, the website responds to the request and prompts the user to pay for the recovery service via the Internet. If the user do not pay fees, then the website continues at step S38, else the website continues at step S37. In step S38, the website disables the request and cancels the recovery service. In step S37, the recovery service is enabled, and the recovery interface is displayed.

In step S39, the user chooses what to recovery and begins to restore data to the client system 4.

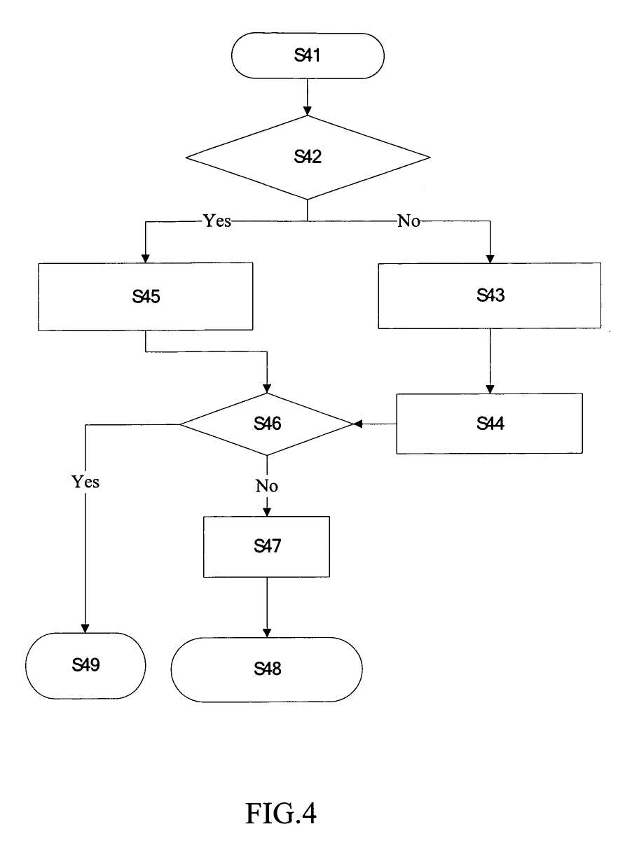

Referring to FIG. 4 shows another schematic flow chart of a backup/recovery method of the preferred embodiment according to the present invention is shown, wherein another backup/recovery service is paid prior to installing the backup/recovery system of the present invention.

In step S41, the user requests the recovery service. In step S42, the backup/restore system determines whether the client system 4 is capable of loading an Operating System (OS) successfully and connecting the server system 1. If the OS cannot be loaded, and the client system 4 cannot connect the server system 1, then the backup/restore system continues at step S43, else the backup/restore system continues at step S45.

In step S43, the user reaches the service provider. The user gets confidential information, such as a password. In step S44, the client system 4 starts executing in the real-mode operating environment. The user inputs the password obtained from the service provider. Then the client system 4 continues at step S46.

In step S45, the client system 4 connects a website. The user may click a button to request for the backup/recovery service. In step S46, the website checks whether the backup/recovery service for the client system 4 has expired. If the service for the user is out of date, then the website continues at step S49, else the backup/restore system continues at step S47.

In step S47, the recovery interface is displayed. In step S48, the user chooses what to recovery and begins to restore data to the client system 4. In step S49, the website disables the request and cancels the recovery service. In addition, the website uninstalls the backup/restore service in the client system 4.

After the client system 4 restores data in the real-mode operating environment, the real-mode recovery function is invalid. The user has to re-login the website in order to active the recovery function. Upon the website checks the client system 4 has implemented the real-mode recovery function; a new password is generated and inputted into the client system 4.

The website manages the service duration of the client system 4 and determines whether the service for the user is out of date, in accordance with the time in the server system 1. This made the alterations of the system time in the client system 4 worthless. While the client system 4 accesses the serving website, the serving website checks the service duration and responds correspondingly.

The backup/recovery system according to the present invention can provide the user with select options. The present invention implements backup/recovery operation in accordance with the sector type of the backup/restore service or the file type of the backup/restore service. The present invention also ensures the uninstall operation of the backup/recovery programs in the client system 4.

By using the backup/recovery system of the present invention, the backup/recovery operation is simple. Furthermore, the user can pay much less for hiring a backup/recovery service. If the user does not implement the recovery operation, then the recovery fee is economized. Hence, the shortcoming that the computer system cannot be restored to a normal state can be entirely avoided.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A network recovery system for providing a backup/restore service via a network, said network recovery system comprising:
a management unit for managing at least one client; and
a processing unit for providing said backup/restore service and transmitting said backup/restore service to said at least one client through said management unit,
wherein said at least one client implements a predetermined operation according to said received backup/restore service.

2. The network recovery system as recited in claim 1, wherein said processing unit includes a network interface for connecting said network and transmitting data.

3. The network recovery system as recited in claim 1, wherein said processing unit includes a backup/restore module for backing up data and restoring a storage device to a previous state.

4. The network recovery system as recited in claim 1, wherein said at least one client includes a browser coupled to a website.

5. The network recovery system as recited in claim 4, wherein said at least one client includes a processing module for issuing a request for said backup/restore service to said website.

6. A recovery system for providing a backup/restore service via a network, said recovery system comprising:
a client system for issuing a request for said backup/restore service; and
a server system for receiving said request via said network;
wherein said client system implements a predetermined backup/restore operation designated in said backup/restore service.

7. The recovery system as recited in claim 6, wherein said server system includes a network interface for connecting said network and transmitting data.

8. The recovery system as recited in claim 6, wherein said server system includes a backup/restore module for backing up data and restoring a storage device to a previous state.

9. The recovery system as recited in claim 6, wherein said client system includes a browser coupled to a website.

10. The recovery system as recited in claim 9, wherein said client system includes a processing module for issuing said request for said backup/restore service to said website.

11. A system for providing a backup/restore service via a network, said system comprising:
a network interface for connecting said network and transmitting data; and
a backup/restore module for backing up data and restoring a storage device to a previous state.

12. The system as recited in claim 11, wherein said network interface connects a client system.

13. The system as recited in claim 12, wherein said client system includes a browser coupled to a website.

14. The system as recited in claim 13, wherein said client system includes a processing module for issuing a request for said backup/restore service to said website.

15. A system for utilizing a backup/restore service via a network, said system comprising:
a browser coupled to a website; and
a processing module for issuing a request for said backup/restore service to said website.

16. The system as recited in claim 15, wherein said website includes a backup/restore system for backing up data and restoring a storage device to a previous state.

17. A recovery method, suitable for providing a backup/restore service via a network, said method comprising the steps of:
issuing a request for said backup/restore service; and
implementing a predetermined backup/restore operation designated in said backup/restore service received through said network.

18. The recovery method according to claim 17, further comprising a payment step in which a client system implements a payment procedure through said network prior to receiving said backup/restore service.

19. A recovery method, suitable for providing a backup/restore service via a network, said method comprising the steps of:
connecting a client system to a website issuing a request for said backup/restore service; and
enabling/disabling a predetermined backup/restore operation implemented in said client system, replied to said request.

20. The recovery method according to claim 19, further comprising a payment step in which said client system implements a payment procedure through said network prior to receiving said backup/restore service.
